(19) United States
(12) Patent Application Publication
(10) Pub. No.: US 2025/0139724 A1
(43) Pub. Date: May 1, 2025

(54) SYSTEMS AND METHODS FOR RECOGNITION OF INDIVIDUALS SUBJECT TO GOVERNMENTAL SANCTIONS

(71) Applicant: Anatoly Kvitnitsky, Alameda, CA (US)

(72) Inventor: Anatoly Kvitnitsky, Alameda, CA (US)

(21) Appl. No.: 18/499,099

(22) Filed: Oct. 31, 2023

(51) Int. Cl. G06Q 50/26; G06Q 30/018

(52) U.S. Cl. CPC G06Q 50/26; G06Q 30/0185

(57) ABSTRACT

According to an aspect of the present invention, there is provided a method comprising scheduling GET requests to retrieve identifying data of the persons subject to governmental scrutiny from one or more of the first data source URLs according to a predefined time interval corresponding with the update schedule for the first data source URL; querying one or more second data source URLs containing one or more images associated with the one or more identifies of the persons subject to governmental scrutiny; storing one or more images one or more images associated with the one or more identifies of persons subject to governmental scrutiny in S3 cloud storage; and training a machine learning model to detect faces in the images associated with the one or more identifies of persons subject to governmental scrutiny.

### BACKGROUND

Financial institutions are subject to myriad rules and regulations aimed at preventing illegal activity. Know your customer (KYC) and anti-money laundering (AML) are often viewed as either similar or one and the same. In fact, KYC, sometimes referred to as Customer Due Diligence (CDD), is a critical component of AML programs. Anti-money laundering (AML) is the broad category of the laws, rules and procedures aimed at deterring money laundering, while customer due diligence (CDD) describes the scrutiny financial institutions (and others) are required to perform to thwart, identify and report violations. These obligations impose substantial burdens on financial institutions, and various technological solutions have been disclosed in the prior art patent literature to reduce the costs and risks for financial institutions.

For example, U.S. Pat. No. 8,412,601 discloses a method to evaluate anti-money laundering risk which may include identifying a person or other legal entity to be evaluated. A country may be selected associated with the person or other legal entity. At least one financial product or financial instrument associated with the person or other legal entity may be selected. The method may also include selecting a customer type associated with the person or other legal entity. A risk rating may be determined based on responses to predetermined criteria related to the selected country, the at least one selected financial product and the selected customer type.

U.S. Pat. No. 8,095,441 discloses a money laundering prevention program administered by a financial institution. A plurality of risk factors associated with a potential for conducting illicit activities in connection with an account held at the financial institution are identified. The risk factors include jurisdiction-based risk factors, entity type-based risk factors, and/or business type-based risk factors. The risk factors are ranked and, based on the rank, each of the risk factors is assigned to a tier. Each of the tiers represents a level of risk that illicit activities will be conducted in connection with the account.

Nevertheless, prior art solutions are lacking at least in terms of accuracy and comprehensiveness, and the burden and danger for financial institutions remains.

### SUMMARY OF INVENTION

Therefore, the present invention provides technological solutions for systems and methods for recognition of individuals subject to governmental sanctions. Financial institutions may find these systems and methods particularly useful, but the systems and methods are not limited to only this use and may find broad application elsewhere as well.

According to an aspect of the present invention, there is provided a computer-implemented method of identifying individuals subject to governmental scrutiny, comprising: defining one or more first data source URLs listing identities of persons subject to governmental scrutiny; sending a GET request to retrieve identifying data of the persons subject to governmental scrutiny from one or more of the first data source URLs; storing one or more identities of the persons subject to governmental scrutiny in a .csv file; scheduling subsequent GET requests to retrieve identifying data of the persons subject to governmental scrutiny from one or more of the first data source URLs according to a predefined time interval corresponding with the update schedule for the first data source URL; querying one or more second data source URLs containing one or more images associated with the one or more identifies of the persons subject to governmental scrutiny; storing one or more images one or more images associated with the one or more identifies of persons subject to governmental scrutiny in S3 cloud storage; training a machine learning model to detect faces in the images associated with the one or more identifies of persons subject to governmental scrutiny; receiving a photograph of a potential customer from a client server via a RESTful API; presenting the photograph of the potential customer to the machine learning model; calculating in the machine learning model a likelihood that the photograph of the potential customer matches an identity of a person subject to governmental scrutiny in the S3 cloud storage; and providing, through the RESTful API to the client server, a prediction of whether the photograph of the potential customer is a particular person subject to governmental scrutiny based on the calculated likelihood.

According to another aspect of the present invention, there is provided a system for identifying individuals subject to governmental scrutiny, comprising: a computer-readable medium; a client server; and one or more processors configured for: defining one or more first data source URLs listing identities of persons subject to governmental scrutiny; sending a GET request to retrieve identifying data of the persons subject to governmental scrutiny from one or more of the first data source URLs; storing one or more identities of the persons subject to governmental scrutiny in a .csv file; scheduling subsequent GET requests to retrieve identifying data of the persons subject to governmental scrutiny from one or more of the first data source URLs according to a predefined time interval corresponding with the update schedule for the first data source URL; querying one or more second data source URLs containing one or more images associated with the one or more identifies of the persons subject to governmental scrutiny; storing one or more images one or more images associated with the one or more identifies of persons subject to governmental scrutiny in S3 cloud storage; training a machine learning model to detect faces in the images associated with the one or more identifies of persons subject to governmental scrutiny; receiving a photograph of a potential customer from a client server via a RESTful API; presenting the photograph of the potential customer to the machine learning model; calculating in the machine learning model a likelihood that the photograph of the potential customer matches an identity of a person subject to governmental scrutiny in the S3 cloud storage; and providing, through the RESTful API to the client server, a prediction of whether the photograph of the potential customer is a particular person subject to governmental scrutiny based on the calculated likelihood.

### BRIEF DESCRIPTION OF THE DRAWINGS

FIG. 1 is a flow chart according to a process in an embodiment.

### DETAILED DESCRIPTION

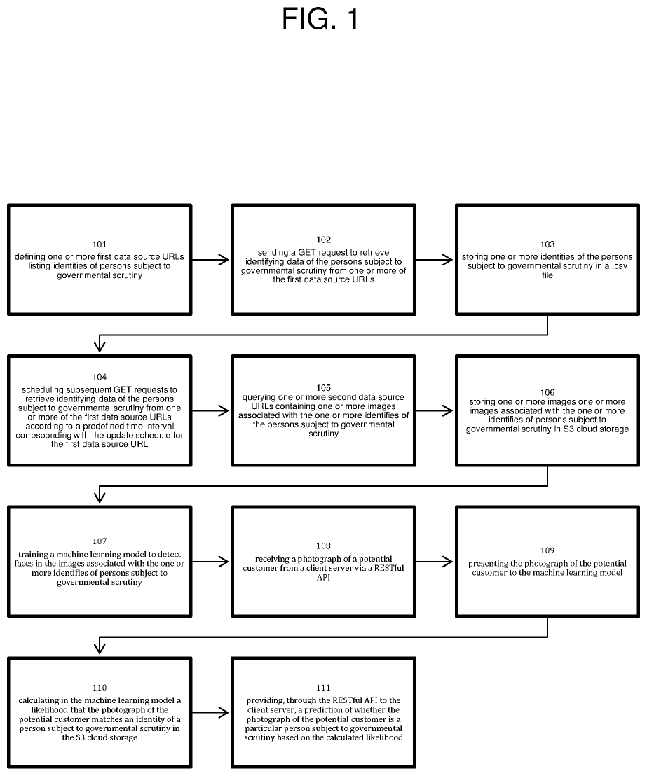

The following refers to the steps depicted in FIG. 1.

Step 101 is defining one or more first data source URLs listing identities of persons subject to governmental scrutiny.

Step 102 is sending a GET request to retrieve identifying data of the persons subject to governmental scrutiny from one or more of the first data source URLs.

Step 103 is storing one or more identities of the persons subject to governmental scrutiny in a .csv file.

Step 104 is scheduling subsequent GET requests to retrieve identifying data of the persons subject to governmental scrutiny from one or more of the first data source URLs according to a predefined time interval corresponding with the update schedule for the first data source URL and updating the .csv file accordingly.

Step 105 is querying one or more second data source URLs containing one or more images associated with the one or more identifies of the persons subject to governmental scrutiny.

Step 106 is storing one or more images one or more images associated with the one or more identifies of persons subject to governmental scrutiny in S3 cloud storage.

Step 107 is training a machine learning model to detect faces in the images associated with the one or more identifies of persons subject to governmental scrutiny.

Step 108 is receiving a photograph of a potential customer from a client server via a RESTful API.

Step 109 is presenting the photograph of the potential customer to the machine learning model.

Step 110 is calculating in the machine learning model a likelihood that the photograph of the potential customer matches an identity of a person subject to governmental scrutiny in the S3 cloud storage.

Step 111 is providing, through the RESTful API to the client server, a prediction of whether the photograph of the potential customer is a particular person subject to governmental scrutiny based on the calculated likelihood.

The following are examples of data which can be downloaded and processed daily (where available) and used by financial and government institutions, as well as by private entities for risk mitigation purposes, in embodiments of the present invention.
Unverified List—U.S. Department of Commerce, Bureau of Industry and Security
Most Wanted Fugitives-Drug Enforcement Administration, U.S. Department of Justice
DFAT list—Australian Government Department of Foreign Affairs and Trade list
Lists of Parties Debarred for AECA (Arms Export Control Act) Convictions—U.S. Department of State
Denied Persons List—U.S. Department of Commerce
Export Administration Regulations list—U.S. Department of Commerce
European Union's list of persons, groups and entities subject to EU financial sanctions
Interpol's fugitives list
List of Excluded Individuals/Entities (LEIE)—U.S. Department of Health and Human Services
Specially Designated Nationals List-Office of Foreign Assets Control, U.S. Department of the Treasury
Entities and Individuals Watch List—Canadian Department of Foreign Affairs and International Trade/Office of Superintendent of Financial Institutions Canada
International Financial Sanctions List—Reserve Bank of Australia
Palestinian Legislative Council (PLC) List—U.S. Department of the Treasury
International financial sanctions in effect in the UK List—United Kingdom Treasury
UN Consolidated Entity and Individual List—UN Security Council List (Al-Qaida, the Taliban and Associated Entities)
FBI Most wanted list—Federal Bureau of Investigation, U.S. Department of Justice
Foreign Agents Registration Act List—U.S. Department of Justice
OFAC sanctions: https://ofac.treasury.gov/ofac-sanctions-lists

Sourcing data from all of the sources in embodiments can involve extracting information from webpages and transferring it to an XLS, CSV, or JSON file.

Embodiments may use a REST API, which is a type of application programming interface (API) that complies with the representational state transfer (REST) model of data representation and communication between two systems (a client and server) over a network such as the Internet. Alternatives to REST in some embodiments include GraphQL, gRPC, WebSockets, MQTT, Event-Driven Architecture (EDA), FALCOR, and Functions.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Similar numerals designate similar elements among the several figures. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A computer-implemented method of identifying individuals subject to governmental scrutiny, comprising:
defining one or more first data source URLs listing identities of persons subject to governmental scrutiny;
sending a GET request to retrieve identifying data of the persons subject to governmental scrutiny from one or more of the first data source URLs;
storing one or more identities of the persons subject to governmental scrutiny in a .csv file;
scheduling subsequent GET requests to retrieve identifying data of the persons subject to governmental scrutiny from one or more of the first data source URLs according to a predefined time interval corresponding with the update schedule for the first data source URL;
querying one or more second data source URLs containing one or more images associated with the one or more identifies of the persons subject to governmental scrutiny;
storing one or more images one or more images associated with the one or more identifies of persons subject to governmental scrutiny in S3 cloud storage;
training a machine learning model to detect faces in the images associated with the one or more identifies of persons subject to governmental scrutiny;
receiving a photograph of a potential customer from a client server via a RESTful API;
presenting the photograph of the potential customer to the machine learning model;
calculating in the machine learning model a likelihood that the photograph of the potential customer matches an identity of a person subject to governmental scrutiny in the S3 cloud storage; and
providing, through the RESTful API to the client server, a prediction of whether the photograph of the potential customer is a particular person subject to governmental scrutiny based on the calculated likelihood.

2. The method of claim 1, wherein the photograph of the potential customer is a photograph contained on an identification document.

3. The method of claim 2, wherein the identification document is a passport.

4. The method of claim 2, wherein the identification document is a driver's license.

5. The method of claim 1, further comprising providing a dossier with the prediction.

6. The method of claim 1, wherein the predefined time interval corresponding with the update schedule for the first data source URL is 24 hours.

7. A system for identifying individuals subject to governmental scrutiny, comprising:
a computer-readable medium;
a client server; and
one or more processors configured for:
defining one or more first data source URLs listing identities of persons subject to governmental scrutiny;
sending a GET request to retrieve identifying data of the persons subject to governmental scrutiny from one or more of the first data source URLs;
storing one or more identities of the persons subject to governmental scrutiny in a .csv file;
scheduling subsequent GET requests to retrieve identifying data of the persons subject to governmental scrutiny from one or more of the first data source URLs according to a predefined time interval corresponding with the update schedule for the first data source URL;
querying one or more second data source URLs containing one or more images associated with the one or more identifies of the persons subject to governmental scrutiny;
storing one or more images one or more images associated with the one or more identifies of persons subject to governmental scrutiny in S3 cloud storage;
training a machine learning model to detect faces in the images associated with the one or more identifies of persons subject to governmental scrutiny;
receiving a photograph of a potential customer from a client server via a RESTful API;
presenting the photograph of the potential customer to the machine learning model;
calculating in the machine learning model a likelihood that the photograph of the potential customer matches an identity of a person subject to governmental scrutiny in the S3 cloud storage; and
providing, through the RESTful API to the client server, a prediction of whether the photograph of the potential customer is a particular person subject to governmental scrutiny based on the calculated likelihood.

8. The system for identifying individuals subject to governmental scrutiny of claim 7, further comprising an input/output device communicatively connected to the client server.

9. The system for identifying a identifying individuals subject to governmental scrutiny of claim 8, wherein the photograph of the potential customer is received from the input/output device.

10. The system for identifying individuals subject to governmental scrutiny of claim 7, further comprising a display device communicatively connected to the client server.

11. The system for identifying individuals subject to governmental scrutiny of claim 10, wherein the prediction is displayed on the display device.
